(19) United States
(12) Patent Application Publication
(10) Pub. No.: US 2011/0132276 A1
(43) Pub. Date: Jun. 9, 2011

(54) TREATMENT PLATFORM FOR ANIMALS

(75) Inventor: Michael Lanny, Bad Wildbad (DE)

(73) Assignee: MLS Lanny GmbH, Bad Wildbad (DE)

(21) Appl. No.: 12/922,015

(22) PCT Filed: Mar. 12, 2009
(86) PCT No.: PCT/EP09/01759

§ 371 Date: Jan. 11, 2011

(30) Foreign Application Priority Data
Mar. 13, 2008 (DE) 10 2008 014 114.3
Mar. 13, 2008 (DE) 20 2008 003 585.6

(51) Int. Cl. A01K 15/04

(52) U.S. Cl. 119/751

(57) ABSTRACT

The invention relates to a treatment platform for animals, particularly for hoofed animals, comprising two side walls (2a, 2b) that are disposed at a distance from each other and define an interior space of the treatment platform (1), and comprising a blocking element (3, 3′) on at least one end (1′, 1″), wherein a passage that is delimited by the two side walls can be locked by said blocking element. The invention provides that feet (4) projecting toward the outside engage on the side walls (2a, 2b), wherein the contact points (P) of said feet with a support (5) carrying the treatment platform (1) are disposed at a distance from the planes defined by the side walls (2a, 2b), and that the side walls (2a, 2b) are disposed at a distance from the plane defined by the lower ends (4′) of the feet (4) of the treatment platform (1).

The invention relates to a treatment platform for animals, in particular for hoofed animals, comprising two side walls that are disposed at a distance from each other and define an interior space of the treatment platform, and comprising at least one end a blocking element, by which a passage delimited by the two side walls can be blocked.

DE 20 2005 012 174 discloses a treatment and training platform for animals, having a circumferential wall defining an interior space, and having at least one entrance door, and a ground plate with which the circumferential wall is directly connected. The ground plate is provided with a vibration device which is built in a way that it receives the animal in a standing state for transferring the vibrations produced by it onto the animal. The circumferential wall is formed by a circumferential surface which is closed on all sides and extends from the ground plate to its upper edge without any recess and only has at its rear end the entrance door. The heights of this circumferential wall is such that a head or neck area of the animal, which is in the interior of the platform delimited by the circumferential wall, extends over the upper edge. Such a totally closed construction of the circumferential wall has got the disadvantage that the animal contained in a such-built treatment and training platform is caged and fixed therein. The treatment and training platform therefore is only suited to impact the animal in it with vibrations produced by the ground plate. A treatment of the animal is hardly possible, since a veterinary or a trainer can—due to the closed design of the circumferential wall—access only the back and the neck of the animal at its best. This is in particular disadvantageous for hoofed animals like camels or horses, in particular for sport camels and sport horses, since their legs are exposed to high loads and are therefore in particular injury-prone. A treatment of the legs, e.g. of a horse, is not possible with the known treatment platform, since—as described above—the person treating the animal has got no access thereto, due to the closed circumferential side wall.

DE 297 13 038 U1 discloses a treatment platform for hoofed animals which serves to force the hoofed animal contained in the treatment platform into an immobilisation state being to a large extend not very painful for the hoofed animal. The treatment platform is simple in its construction and requires only little maintenance. For that purpose it is provided that the treatment platform is formed as a frame work construction having lower and upper cross bars, which are connected with front and rear support bars. The lower cross bar extends in its front area, immediately next to the front support bar, outwardly and upwardly and is provided in such a distance from the ground plate on the front support bar that the outwardly extending section of the lower cross bar receives and supports the shoulder of the hoofed animal. The upper cross bar of the treatment platform stabilizes the treatment platform during the treatment. On the front supporting bars an outdoor is arranged, which has got two movable wings defining an open frame. The wings of the outdoor are, in their first position, when the hoofed animal enters the treatment platform, slightly angled towards the interior, so that the hoofed animal pushes the wings with its shoulders outwards and releases a locking mechanism, which is provided on the frame work construction. The head of the hoofed animal is positioned with a certain amount of movability within the inner side bars and the shoulders of the hoofed animal rest in sidewards projecting openings of the lower cross bar. By these measures a sedate standing of the hoofed animal in the treatment platform should be achieved. When the hoofed animal is positioned in the front part of the treatment platform, then at the rear end of the treatment platform a frame, which has a splash guard, is lowered and closes the treatment platform. Then the person treating the claws puts a belt around the waist of the hoofed animal and the hoofed animal is lifted by this belt for a load relieving of its front feet.

This known treatment platform too has got the disadvantage that the animal contained in it is caged and must be fixed for its treatment. The known treatment platform allows—due to its frame work construction—that the person treating the animal contained in the treatment platform has access to it. But the danger exists that limbs of the treating person, in particular hands or arms, can be broken, when, e.g. by a panic reaction of the animal, the arm or the hand of the treating person is pressed against an element of the frame work construction by the animal.

DE 102 46 455 B4 discloses a treatment platform for animals, which has got a substantially rectangular ground frame being provided by two vertical rear posts and two vertical front posts and vertical middle and upper cross bars connected to these posts. At the lower end of the vertical posts arms are arranged, on which wheels extending outwardly and rotating around the axis are provided.

It is the object of the present invention to provide a treatment platform of the afore-mentioned kind having a sufficiently secure access of a person being outside of the treatment platform to the animal.

This problem is solved according to the invention in that the side walls are disposed at a distance from a plane defined by the lower ends of legs of the treatment platform, and that on the sidewalls legs engage which project outwardly and downwards, so that contact points of the legs on a support bearing the treatment platform are distant from the planes defined by the side walls.

By the measures according to the invention a treatment platform is provided which has got the advantage that the legs projecting and extending from the side walls are away from the striking distance of the feet of the animals, so that the animal cannot hurt itself even not in the case of a sudden kicking out. Due to the elevated position of the side walls, the foot area of the animal is easily accessible for the treating person, so that good treatment possibilities for the animal contained in the inventive treatment platform are given. Since this treatment area is substantially free of parts of the treatment platform, there is no longer the danger that an arm or a hand of the treating person is broken or sheared, as it is likely to occur in treatment platforms known in the state of the art, which have longitudinal or cross bars in the foot area against which an extremity of the treating person can be pressed undesiredly.

A further advantage of the treatment platform described is that, due to the broad extension of the legs projecting from the side walls of the treatment platform, this treatment platform is sufficiently stationary, so that in an advantageous matter it is not compulsory to fix the treatment platform onto the support bearing it.

An advantageous further development of the invention provides that the treatment platform is substantially larger as the length of the animal to be treated in it. Such a measure has got the advantage that the animal can be positioned in the longitudinal direction of the treatment platform. This is in particular of advantage when an external treatment device is used, since then the animal contained in the treatment platform can be positioned in respect to the treatment device in an appropriate manner.

An advantageous further development of the invention provides that the width of the treatment platform is substantially larger than the width of the animal to be treated in it. Such a measure has got the advantage that the animal contained in the treatment platform is confined in the treatment platform, but has got sufficient space to move in order to be positioned in an appropriate position for the treatment to be performed or can position itself.

An advantageous further development of the invention provides that at least one side wall is formed by longitudinal bars and cross bars, wherein between at least two longitudinal bars at least one free space is provided. Such a design of the inventive treatment platform has got the advantage that the torso of the animal is accessible for the treating person too.

An advantageous further development of the invention provides that the inventive treatment platform is built protrudingly at its front end. Such a measure has got the advantage that the treating person has got good access to the front part of the animal.

An advantageous further development of the invention provides that at least on one side wall an impact protection is provided. Such a measure has got the advantage that the foot area of the animal can be protected, if required.

Further advantageous developments of the invention are the subject matter of the depending claims.

Further details and advantages of the invention can be seen from the embodiments, which are described with reference to the figures. These show:

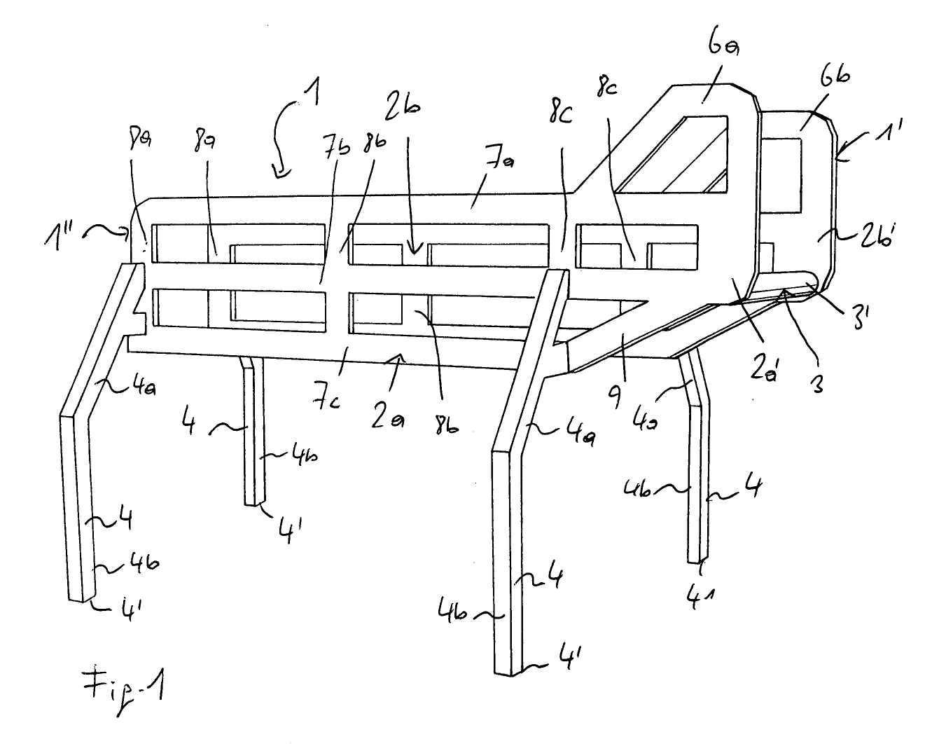

FIG. 1 a perspective view of a first embodiment of the device,

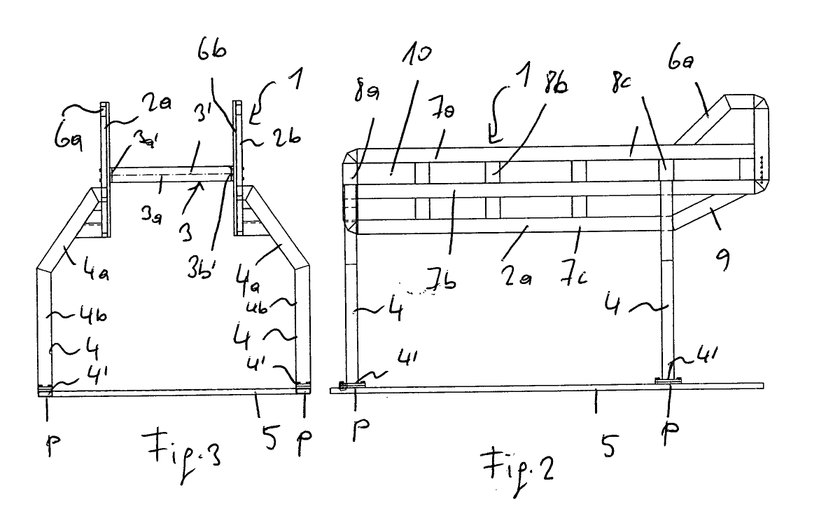

FIG. 2 a side view of the first embodiment,

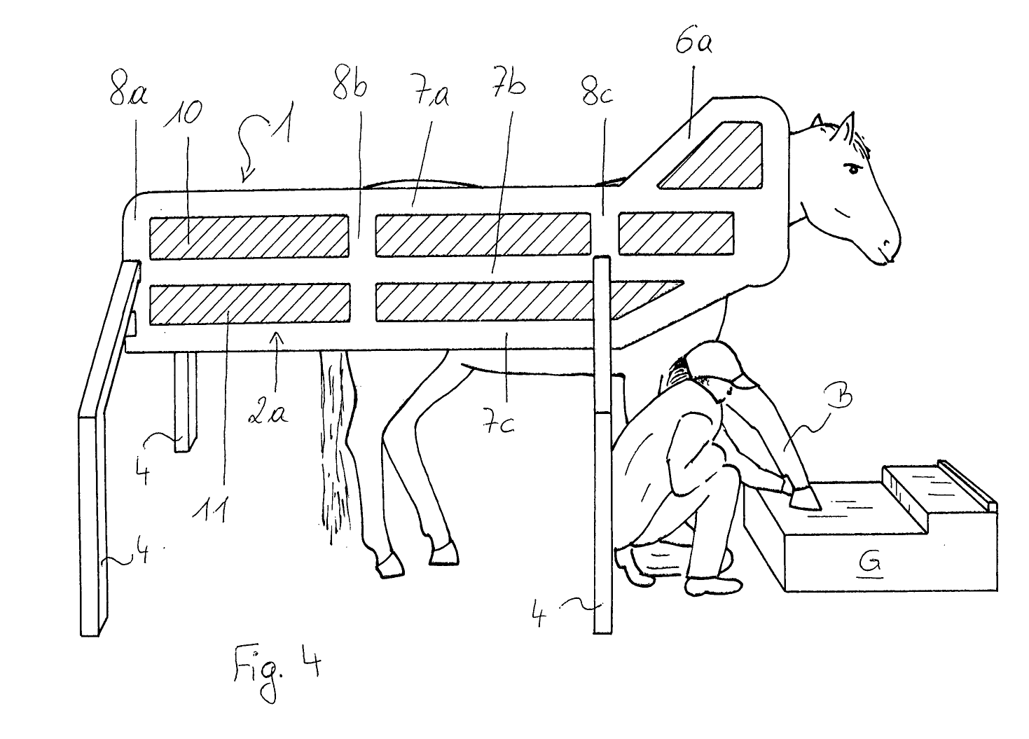

FIG. 3 a front view of the first embodiment,

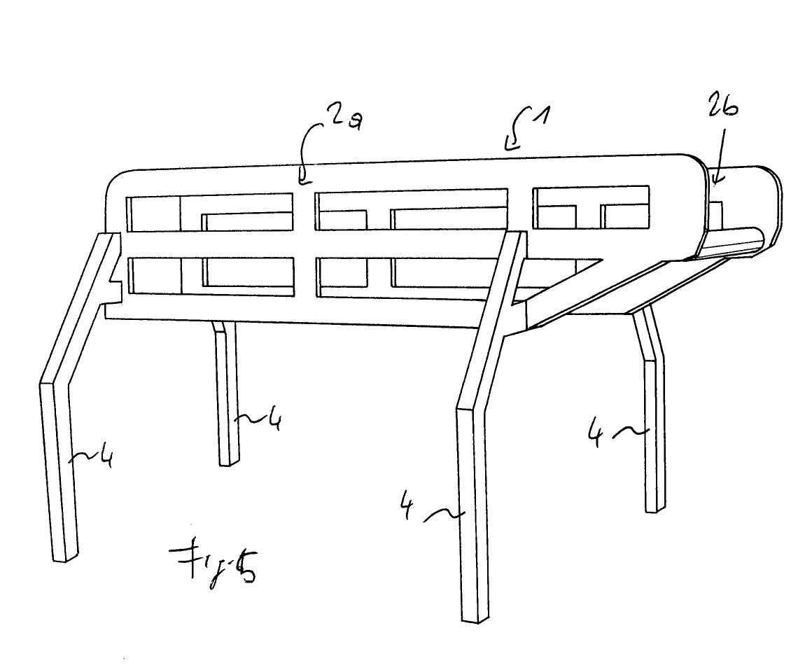

FIG. 4 an exemplary treatment of a horse in a treatment platform according to the FIGS. 1-3, and

FIG. 5 a perspective view of a second embodiment.

In FIGS. 1 to 4 a first embodiment of a treatment platform for animals, in particular for hoofed animals, is shown and denoted generally with 1. For the sake of an easier description, in the following only the term “treatment platform” is used, but under this expression of course a “training platform” or a “treatment and training platform” is to be understood too. The treatment platform 1 has got two side walls 2a, 2b, which are—in the embodiment shown here—connected on their front end 2a′, 2b′ by a cross bar 3′. The animal contained in the interior space of the treatment platform 1 delimited by the two side walls 2a, 2b, in particular a horse (see FIG. 4), is barred by this cross bar 3′ acting as a blocking element 3 to leave the treatment platform 1 at its front end 1′ in a forward direction. The blocking element 3 can be connected rigidly with the side walls 2a, 2b. But it is also possible that the blocking element 3 is such that the front passage of the treatment platform 1 can be unblocked by an appropriate unlocking mechanism so that the horse can leave the treatment platform 1 in a forward direction. It furthermore can be provided that the entrance of the treatment platform 1, this means its rear end 1″, can be blocked by means of a further cross bar or a like blocking element.

Legs 4 engage on the side walls 2a, 2b, which touch down on a base plate 5 (see FIGS. 2 and 3) and which are preferably fixed on the base plate 5. But it is possible too that the legs 4 are touching down directly on the ground carrying the treatment platform 1 and are preferably anchored therein.

The legs 4 connected with the side walls 2a, 2b now do not—as it is the case of the known treatment platforms—run in the plane of the side walls 2a, 2b, but project outwardly from the side walls 2a, 2b, so that the contact points P of the legs 4 on the ground plate 5 or on the ground is—as it is best seen from the figures—are disposed distantly from a plane defined by the side walls 2a, 2b.

As it can be seen from the figures, the side walls 2a, 2b leave the lower part of the treatment platform 1 open and are provided in the level of the torso area of the animal to be treated (see FIG. 4), in such a way that it is barred by the side walls 2a, 2b to leave the treatment platform 1 in a sideways direction.

In the embodiment shown, the legs 4 are—as it can be seen easily from FIGS. 1 and 3—are designed in such a way that the legs 4 have got an upper part 4a, which projects from the side walls 2a, 2b in a downwardly inclined direction, and runs over in a second part 4b, which is essentially parallel to the plane defined by the respective side walls 2a, 2b. Due to this widely protruding design, the lower ends 4′ of the legs 4 of the treatment platform 1 are hence disposed far away from the planes defined by the side walls 2a, 2b. Such a design has got the advantage that in this way a high stability of the treatment platform 1 is achieved, so that it is not compulsory to fix it on the ground plate 5 or a surface providing the support of the treatment platform. It is preferred that on the lower ends 4′ of the legs 4 an anti-slip support is provided, which counteracts a displacement of the treatment platform 1.

It is obvious that the afore described, bow- or bride-like design of the legs 4 with an inclined upper part 4a and a substantially vertically extending lower part 4b is not compulsory. It is possible too that the legs 4 project essentially straight from the side wall 2a, 2b to the ground plate or to the support. Even a combination of the two afore-mentioned designs as well as designs in which single legs deviate in their form are possible, as long as a projecting arrangement of the legs is achieved.

The design of the treatment platform 1 described before has got the advantage that the feet of the animal are well-accessible, since the lower part of the treatment platform 1, the “foot area”, is not obstructed by the side walls 2a, 2b. The legs 4 of the treatment platform 1 protruding sidewardly have got the advantage that they are outside of the striking area of the feet of the animal, so that it cannot hurt itself, even not by suddenly kicking out. A further advantage of the design described is that the risk of injuries of the person treating the animal contained in the treatment platform 1 is reduced, since the risk that an arm or a hand of the treating person is broken or sheared by an extremity of the animal impacting on it, which can happen when the treatment platform has got in its foot section longitudinal or cross bars, against which an extremity of the treating person can be pressed, is reduced.

As it can be best seen from FIG. 4, the treatment platform 1 is provided essentially longer than the length of the animal to be treated in it. It is preferred that the side walls 2a, 2b have got a length which is approximately 1.5 to 2 times the length of the animal. Such a measure has got the advantage that a forward or backward moving of the animal contained between the side walls 2a, 2b is possible, so that in particular its links can be put into a desired position. This movability of the animal in the longitudinal direction of the treatment platform 1 is in particular of advantage if—as shown in FIG. 4—a front leg B of the animal is to be put on a treatment device G, e.g. a vibration plate as it is described in the utility model DE 20 2007 016 167 of the applicant. For this treatment, it is necessary that the animal is led to the treatment device G in such a way that the leg B to be treated rests on the treatment device G in a desired way. Due to the described design of the treatment platform 1 the animal positioned in it has got the possibility to balance itself, preferably in a way that the leg B resting on the treatment device G is only slightly loaded.

In this context, it is advantageous that the width of the treatment platform 1 is essentially larger than the width of the animal to be contained therein, so that the animal to be treated in the treatment platform can not only positioned in the longitudinal direction of the treatment platform, but also sideways too. It is preferred that the distance between the side walls 2a, 2b is approximately 1, 5 to 2 times the width of the animal.

A further advantage of design described is that the animal is contained in the treatment platform 1 in a relative freely movable way, which counteracts panic reactions. In particular for the diagnosis or the treatment of an injured animal it is important that this animal can move as naturally as possible, since only then an injury or a dysfunction of the muscosceletal system of the animal can be inferred with a sufficient reliability.

Since the legs 4 are preferably disposed distant from each other in the rear section 1″ of the treatment platform 1 too, it is possible that one or both hind legs of the animal can be positioned on the treatment device G. This device is then provided in the treatment platform 1 between the rear legs 4 and the animal is positioned on it via a backward movement.

As it can be seen from FIG. 1 too, the side walls 2a, 2b are provided in their front part, in the “head area” of the treatment platform 1 and the animal contained therein, in a protruding way, by providing attachments 6a, 6b, which are preferably formed integrally with an upper longitudinal bar 7a of the side walls 2a, 2b. Such a measure has got the advantage that a kind of blinders for the animals are provided, which furthermore has got the effect that the animal contained in the treatment platform 1, in particular a horse, cannot jump over the side walls 2a, 2b of the treatment platform 1, when rearing up.

It is preferred too, that the side walls 2a, 2b have got a section 9 extending upwardly in the area between their front legs 4 and their front ends 2a′, 2b′. Such a measure has got the advantage that space for a treating person is provided, e.g. for putting a leg of the animal onto the treatment device G, as it is shown in FIG. 4.

As shown in FIGS. 1 to 4, the first embodiment provides that the side walls 2a, 2b are formed by the upper longitudinal bar 7a, a middle longitudinal bar 7b being spaced to it, and a lower longitudinal bar 7c once more spaced to the middle longitudinal bar 7b, which are connected via supporting bars 8a-8c. Such a design not only has got the advantage that the treatment platform 1 described is of small weight. Spaces 10 being provided between the longitudinal bars 7a-7c allow the treating person to access the torso area of the animal. It is possible too that, instead of the three longitudinal bars 7a-7c described here, only one longitudinal bar or more than three longitudinal bars are provided.

Optionally, the treatment platform 1 may have an impact protection (not shown), which is formed of a resilient material and can be arranged on the lower ends of the side walls 2a, 2b and is preferably removable. It is possible to arrange the impact protection on the side walls 2a, 2b in a curtain-like matter, so that it can be removed if it is not longer required. It is preferred that the impact protection is made of a plastic material and is preferably cushioned.

Referring to FIG. 4, it has got to be noted that the embodiment shown there deviates from the first embodiment shown in FIG. 1 in that on the inner sides of the side walls 2a, 2b a padding 11 is provided, which extends preferably to the attachments 6a, 6b too.

In FIG. 5 a second embodiment of the treatment platform 1 is shown, the basic design of which is substantially the same as the one of the first embodiment, so that corresponding parts are denoted with the same reference numerals and are not described in details once more. The main difference between the two embodiments is—as it can be easily seen by a comparison of FIGS. 1 and 5—that the second embodiment of the treatment platform 1 does not have the attachments 6a, 6b functioning as blinders. Such a treatment platform is sufficient in the case when the animals to be treated do not—like animals which tend to try to escape like e.g. horses—tend to rear up.

To ensure that a risk of injury of an animal contained in the treatment platform 1 caused by rearing up or a similar panic reaction does not come into existence, it is preferred that the elongated body 3a of the cross bar 3′ has got on its ends 3a′, 3a″ (see FIG. 3) blocking elements (not shown) by which an engagement of the cross bar 3′ with the side walls 2a, 2b can be established. The cross bar 3a has got spring means by which at least one or both blocking elements arranged in the cross bar 3′ can be acted upon with a spring force, whereby the spring means generating the spring force have got a characteristic line which is chosen such that the resilient force generated by the spring device and acting upon at least one of the blocking elements raises during a transition area from a first spring force into a higher second spring force. Such a cross bar 3′ makes it possible to establish a kind of panic function for the blocking element 3. It blocks the passage between the side walls 2a, 2b when under normal load, but quits this blocking function and releases the passage when higher loaded. Such a blocking element is described in the utility model DE 20 2007 015 990 of the applicant, which is referred to in order to avoid unnecessary repetitions and its disclosure is incorporated in this application by way of reference.

Summarizing, it must be stated that by the measures described a treatment platform 1 is provided which is constructed in a simple way, has got a sufficient movability of the animal contained in it and allows a person standing outside of the treatment platform to access the animal contained therein in a sufficient safe way. The widely projecting structure of the legs 4 protruding from the side walls 2a, 2b has got the advantage that the legs 4 are outside of the striking area of the legs of the animal. The elevated design of the side walls 2a, 2b has got the advantage that a sufficient large treatment space for the legs of the animal is provided.

1. A treatment platform for animals, in particular for hoofed animals, comprising two side walls (2a, 2b) that are disposed at a distance from each other and define an interior space of the treatment platform (1), wherein the side walls (2a, 2b) are disposed at a distance from a plane defined by the lower ends (4′) of legs (4) of the treatment platform (1), and wherein on the side walls (2a, 2b) legs (4) engage which are project outwardly and downwardly so that contact points (P) of the legs (4) on a support (5) bearing the treatment platform (1) are distant from the planes defined by the side walls (2a, 2b).

2. The treatment platform according to claim 1, characterized in that at least one leg (4) of the treatment platform (1) has got a first part (4a) extending from the side wall (2a, 2b) downwardly inclined, and that a second part (4b) following the first part (4a) is essentially parallel to the plane defined by the corresponding side wall (2a, 2b).

3. The treatment platform according to claim 1, characterized in that at least one leg (4) protrudes essentially downwardly inclined from the side wall (2a, 2b) and is essentially straight.

4. The treatment platform according to claim 1, characterized in that at least one leg (4) has got on its end (4′) adjacent to the side wall (2a, 2b) a fogged shape.

5. The treatment platform according to claim 1, characterized in that the length of the side wall (2a, 2b) is larger than the length of the animal to be contained in the treatment platform.

6. The treatment platform according to claim 1, characterized in that the distance between the side walls (2a, 2b) is essentially larger than the width of the animal to be contained in the treatment platform (1).

7. The treatment platform according to claim 1, characterized in that the treatment platform has got a ground plate (5) which is connected with the legs (4).

8. The treatment platform according to claim 1, characterized in that at least one side wall (2a, 2b) has got at least one longitudinal bar (7a-7c).

9. The treatment platform according to claim 8, characterized in that at least one side wall (2a, 2b) has got at least two spaced apart longitudinal bars (7a-7c).

10. The treatment platform according to claim 8, characterized in that at least two longitudinal bars (7a, 7b; 7b, 7c) are connected via a support bar (8a-8c).

11. The treatment platform according to claim 8, characterized in that between at least two longitudinal bars (7a-7c) at least one free space (10) is provided.

12. The treatment platform according to claim 1, characterized in that at least one side wall (2a, 2b) has got on its front end (2a′, 2b′) an attachment (6a, 6b).

13. The treatment platform according to claim 1, characterized in that the treatment platform (1) has got in its front end (1′) a protruding shape.

14. The treatment platform according to claim 13, characterized in that at least one side wall (2a, 2b) has got in its front area (2a′, 2b′) an upwardly inclined area (9).

15. The treatment platform according to claim 1, characterized in that the blocking element (3) is provided as a cross bar (3′).

16. The treatment platform according to claim 15, characterized in that the cross bar (3′) has got an elongated body (3a), on whose both ends (3a′, 3a″) blocking elements are arranged, by which an engagement of the cross bar (3′) with the side walls (2a, 2b) can be effected, and that the cross bar (3′) has got resilient means by which at least one blocking element can be acted upon with a spring force, and that the characteristic line of the resilient means is chosen such that the spring force by which the resilient means acts upon the blocking element increases within a first transition area from a first spring force to a bigger second spring force.

17. The treatment platform according to claim 1, characterized in that at least one side wall (2a, 2b) has got a padding (11).

18. The treatment platform, according to claim 1, further comprising a blocking element (3, 3′) at least on one end (1′, 1″) of the platform, which may be used to block a passage delimited by the two side walls (2a, 2b).
